(19) United States
(12) Patent Application Publication
(10) Pub. No.: US 2017/0113435 A1
(43) Pub. Date: Apr. 27, 2017

(54) METHOD FOR PRODUCING A VISIBLE COVERING

(71) Applicant: Holger MAROHN, Krefeld (DE)

(72) Inventor: Holger MAROHN, Krefeld (DE)

(21) Appl. No.: 15/345,911

(22) Filed: Nov. 8, 2016

Related U.S. Application Data
(63) Continuation of application No. 13/375,660, filed on Mar. 13, 2012.

(30) Foreign Application Priority Data
Jun. 2, 2009 (DE) 10 2009 023 421.7

(51) Int. Cl. B32B 5/30; B32B 5/02; B32B 38/00; B32B 7/12; B32B 21/02; B32B 3/30; B32B 5/16

(52) U.S. Cl. CPC B32B 5/30; B32B 3/30; B32B 5/024; B32B 5/022; B32B 5/16; B32B 7/12; B32B 21/02; B32B 38/0012; B32B 2038/0016; B32B 2471/00

(57) ABSTRACT

The invention relates to a method for producing a visible covering (1) comprising the following steps: mixing a stabilising agent with a granular material (2), introducing the granular material (2) into a receiver (3) to form a moulded article (4), connecting of at least a surface layer (9) of the moulded article with a carrier layer (10), removing the composite of surface layer (9) and carrier layer (10), wherein the visible covering (1) is obtained. The invention further related to a visible covering (1) produced with the method according to the invention and the use thereof as a facing of ceilings, walls, floors, doors, roofs and/or tabletops.

The invention relates to a method for producing a visible covering, a visible covering produced by the method according to the invention and the use of this as a facing of ceilings, walls, floors, doors, roofs and/or tabletops.

Visible coverings of the kind mentioned above are in principle known and are generally used as decorative surfaces for floors, ceilings, furniture and suchlike.

The visible coverings can consist of the most varied of materials, for example natural stone, such as slate, marble, granite or ceramic materials. The advantage of these materials is their decorative appearance and their wear resistance.

It is, however, disadvantageous that these materials are usually brittle, heavy and inflexible, which limits their usage possibilities for various applications. Furthermore, fixing these materials to the substrate is usually cost-intensive and only possible using heavy construction materials such as mortar, cement or similar materials. A further disadvantage of such materials is that the substrates to which they are secured must meet high demands in terms of stability and flexural strength. Thus for example it is only possible with some difficulty to fit natural stone onto wood constructions, since these expand, contract or sag as a result of variations in temperature and/or humidity, which over time can lead to damage such as for example cracks in the materials.

It is known that natural stone laminates, such as for example sandstone laminates, can be obtained in sand pits by levelling the sand walls, applying a rear-side reinforcement to the walls and then applying a dispersion binder. Following drying and/or polymerisation of the dispersion binder the resultant laminate is removed. On the visible face of the laminate, the colouring and topography of the wall are modelled.

A substantial disadvantage of this method is that it is highly dependent upon the weather. Thus in cold weather, even if the surface to be produced is covered over, the laminate cannot be obtained without loss of quality. In addition, in this case substantially longer drying and hardening times are necessary.

A further disadvantageous effect of the weather is rain. When it rains the ground absorbs water, which manifests itself on the excavation surfaces as an increase in the inherent moisture up to hazy discharges of water. This in turn leads to serious defects in the laminate to the point of making this unusable.

A further disadvantage is also the differing stability of the surface to be worked. Depending on the geological conditions this can fluctuate greatly and requires constant adaptation of the adhesives and the binding agents.

Finally, with this method—even if stronger adhesives or binding agents are used—it is not possible to work hard natural stone types such as for example granite and marble.

Attempts have previously been made to solve the abovementioned problems by cutting thin sheets of stone materials and adhering these to a carrier such as for example a metal substrate. The disadvantage of this method, however, is that the cutting out of thin layers is difficult to achieve and is also time-consuming. Furthermore the layer products obtained are usually brittle and fragile so that their usage possibilities are limited.

From WO 2008/022812 a flexible flat material is known comprising a surface layer with a layer of multilayered stone material, a flexible, carrier layer with high tensile strength, which bears the surface layer, and a layer of adhesive for securing the flat material to the substrate.

From WO 01/75246 A1 a method is also known for producing consolidated sand layers, in which webs of a sand layer and a support layer are formed. In this method a support layer is placed on a smoothed sand surface, the support layer is brought into contact with a binding agent or adhesive consolidating the upper sand layer and the respective web created is then lifted off.

In order to secure the structuring of the sand layer before lifting off the web, it is proposed that the sand filling is surrounded by walls.

A disadvantage of proceeding in this way is that enclosing of the sand filling with walls is suitable to only a limited extent for reliably securing the structuring of the sand. Because of its fine granularity sand tends to trickle when it is jolted, whereby its original structuring can be lost.

An object of the invention was to overcome the abovementioned disadvantages in the state of the art.

This object is achieved by a method for producing a visible covering comprising the following steps:
a) mixing a granular material with a stabilising agent;
b) introducing the granular material into a receiver to form a moulded article;
c) connecting at least a surface layer of the moulded article with a carrier layer;
d) removing the composite of surface layer and carrier layer, wherein the visible covering is obtained.

The method according to the invention is distinguished in relation to the prior art in particular in that the granular material is mixed with a stabilising agent and then connected with a carrier layer. The introduction of the stabilising agent leads to an increase in the dimensional stability of the granular material, whereby its structuring can be secured even when being jolted, for example during storage and transport. In this way a desired structuring in the granular material can be specified, preserved and if necessary transferred to the visible covering.

The method according to the invention is further distinguished in that with a comparatively small quantity of granular material a visible covering can be produced with a continuous decorative visible surface. Thus with the method according to the invention the available resources can be used particularly effectively. This advantage is important in particular when using expensive and/or scarce materials.

A further advantage of the method according to the invention is that the serial production of visible coverings in an atmosphere that is not weather-dependent is made possible. In addition to this, with the method according to the invention visible coverings of consistent quality can be produced which is in particular an advantage if quality standards, such as for example in building linings, have to be adhered to.

In the first step of the method according to the invention a granular material is mixed with a stabilising agent.

For the granular material in principle the most varied of substances can be used. Particularly attractive visible coverings are achieved with the use of natural stone, preferably sandstone, quartz, quartz sand, granite, slate, marble, glass, tuff, schungite, quartzite, plastic, preferably acrylates, polyamides, wood and/or metal, in particular non-corrosive metals, especially copper, bronze, brass and aluminium.

The use of a granulate as the granular material is particularly expedient, since granulates have good pourability and are easy to handle. Practical trials have shown that with granulates having a D₅₀ value of 0.01 mm to 5 mm, preferably of 0.02 mm to 1 mm and/or a mean grain size of 0.05 mm to 5 mm, preferably of 0.1 to 1.5 mm, particularly good results can be achieved.

In principle granular materials with any grading curve structure can be used. Particularly advantageous, however, is the use of a granular material with a grading curve structure which allows the formation of a dense material structure without a large amount of compacting energy having to be applied. Which grading curve structure is suitable for the respective granular material used can be identified by a person skilled in the art by simple trials.

Practical trials have shown that when powders, sands, gravels and/or mixtures of these are used as the granular material, especially good results are achieved. Particularly good results are achieved with powders, sands, gravels and/or mixtures thereof which comprise the following average grain sizes:
Powders: 20-100 μm
Sands: 50-1000 μm
Gravels: 0.1-5.0 mm, preferably 0.1-1.5 mm.

In order to improve the properties of the visible covering according to the invention the granular material can also comprise auxiliary agents such as fire-proofing additives, hydrophobing agents, odour and/or contaminant absorbers, preferably titanium dioxide, and/or colorants, preferably pigments.

Particularly preferred is the use of a granular material, which preferably during production has UV-sensitive TiO₂ compounds for example in the form of powders or colloidal solutions mixed in. If the visible covering is used as an outside wall lining, under the effect of sunlight (UV) such addition causes the decomposition of organic particles, that is to say that moss, algae, contamination etc. can be destroyed and washed off. As a result of this a visible covering with a long-lasting clean surface can be obtained.

The granular material can further comprise a reinforcing material. As the reinforcing material for example high-strength fibres can be used. High-strength fibres are known and comprise organic and inorganic reinforcing fibres, such as for example glass fibres, carbon fibres, Kevlar fibres, construction fibres and the like. The fibres can take the form of cut individual fibres. Here it is advantageous if the length of the individual fibres is no greater than the largest grain of the granular material. It is also conceivable that the fibres are present in the form of a woven or non-woven material, in the form of a mat, in the form of a layer of substantially continuous filaments, in the form of a braid or strand of fibres.

According to the invention the granular material is mixed with a stabilising agent. According to the invention the term stabilising agent means substances which are suitable for ensuring the structure of the granular material at least temporarily. In principle, the most varied of substances can be used as stabilising agents. Through the selection of the stabilising agent the extent of the safeguarding of the structure of the granular material can be selectively adjusted. Which stabilising agent is suitable for the granular material used in each case in order to achieve a desired stabilisation, can be determined by a person skilled in the art by simple trials. For most applications particularly good stabilising agents are grit and/or water.

A substantial criterion for the selection of the stabilising agent is the extent of its stabilising effect. Thus in some cases it may be expedient to use a stabilising agent with only a weak stabilising effect. The advantage of using a weak stabilising agent is that the structuring of the granular material remains changeable. Thus when a weak stabilising agent is used it still remains possible to change an undesired structuring even after mixing with the stabilising agent.

Particularly suitable weak stabilising agents according to the invention are water, swelling clay, methyl cellulose, polysaccharides, polyvinyl alcohol, casein, loam, saponite, sephiolite, china-clay, zinc oxide and/or water glass.

In some cases on the other hand it may be useful to use a stabilising agent with a strong stabilising effect. According to the invention particularly suitable strong stabilising agents are binding agents and or adhesives such as for example redispersible dispersion powders, plastic dispersions, resin emulsions. As is known to the person skilled in the art, the strength of the effect achieved with the stabilising agent can also be controlled by the quantity used.

The advantage of strong stabilisation of the granular material is that a particularly reliable securing of a specified structure can be achieved. In addition to this, the surface structure of the granular material is secured so that when the visible covering is handled there is no collapse or fall in of the visible surface, for example by trickling.

In some cases it is desirable to secure the structure of the granular material only temporarily. To this end a stabilising agent can be used, the stabilisation effect of which is reversible. A reversible stabilising agent according to the invention is understood to mean a stabilising agent whose stabilising effect can be reversed.

Suitable reversible stabilising agents are for example water, cellulose, starches, saccharide, polyvinyl alcohol, casein, swelling clay.

The means by which the stabilising effect of reversible stabilising agents can be reversed is dependent upon the nature of the stabilising agent used in each case is known to the person skilled in the art. If, for example, water is used as a reversible stabilising agent, the stabilising effect thereof can be reversed in a simple manner by drying. The stabilising effect of binding agents such as cellulose, starch and/or saccharide can be reversed by the addition of solvents such as for example water.

The advantage of using a reversible stabilising agent is that it combines the advantages of weaker and stronger stabilising agents. Thus when a reversible stabilising agent is used it is possible to change a specified structuring in the granular material even after mixing with the stabilising agent. Nevertheless a durable securing of the structuring can be achieved. Furthermore, hardening of the stabilising agent, for example if the surface of the moulded article is too hard for removal of the visible covering and/or the thickness of the surface layer is uneven in an undesirable manner, can be reversed.

In some cases it is in turn desirable to use an irreversible stabilising agent. The advantage of using irreversible stabilising agents is that a permanent stabilisation of the structure pattern can be obtained. As a result of this the visible covering formed also comprises a high structural stability with an evenly thick, closed surface layer. Suitable irreversible stabilising agents are for example epoxy emulsions, polyurethane emulsions, thermoplast dispersions such as acrylate, propione, butadiene styrene and/or water glass.

It is particularly expedient if as the stabilising agent an adhesive and/or binding agent is used, the active substance of which is suitable for indoor or outdoor application.

The use according to the invention of a stabilising agent also allows a particularly preferred aspect of the invention. According to this aspect at least one recess, for example a crack or a furrow is formed in the moulded article. It is an advantage of the use of the stabilising agent that it stabilises the recess formed and can thus prevent the recess filling again in an undesirable manner. Subsequently, according to the invention at least a part of the recess is filled with a contrast medium, wherein an artificial structure pattern forms.

With this aspect of the invention a particularly decorative visible covering can be produced with an artificial structure pattern.

The formation of the recess can be performed in various ways. Particularly good results are achieved if the recess is formed by a change in the spatial position of the moulded article. Such a change can be caused for example by knocking or agitating the receiver.

According to a further preferred embodiment of the invention the recess in the moulded article is formed by a deformation of the floor area of the receiver and/or by a deformation of a film arranged between the floor area of the receiver and the moulded article. To this end the floor area of the receiver and/or the film can be designed to be at least partially deformable. With this measure particularly attractive results can be obtained.

The deformation of the floor area and/or of the film can take place in various ways. Good results are achieved with a selective, for example lateral, raising of the floor area.

According to a particularly preferred embodiment of the invention the deformation of the floor area and/or of the film arranged between the floor area of the receiver and the moulded article is by impressing an impression body into the floor area of the moulded article and/or into the film. Here the impression body can be substantially dimensionally stable or also deformable. To this end the impression of a deformable solid body is particularly suitable, preferably into the side of the floor area facing away from the moulded article.

The recess formed according to the above method is according to the invention provided with a contrast medium, wherein an artificial structure pattern results. This structure pattern provides the visible covering with a particularly natural-looking appearance.

The appearance of the artificial structure pattern is substantially determined by the form and number of the recesses and can in particular be affected by the manner in which the spatial position of the moulded article is changed or its floor area deformed. A person skilled in the art can find out by simple testing with which measures he can achieve a desired structure pattern.

A further substantial factor in the appearance of the synthetic structure pattern is the selection of the contrast medium. According to the invention the term contrast medium means materials which from an optical and/or tactile point of view differ from the granular material.

In principle, as contrast medium the same materials as for the granular material can be used, provided that they differ in an optical and tactile fashion from the granular material. This distinction can, for example, be created by a difference in colour, structure, composition, grain size or grading curve structure. With a colour contrast between the granular material and the contrast medium particularly attractive results can be achieved. A colour contrast here can be achieved both by a difference in composition of the materials and by the use of colorants such as dyes and pigments.

The use of solid materials as contrast media is preferred according to the invention for practical considerations.

In principle, however, liquids can also be used, provided that these can be solidified.

In order to improve the properties of the visible covering the contrast medium can also comprise auxiliary agents such as fire-proofing additives, hydrophobing agents, odour and/or contaminant absorbers, preferably titanium dioxide, and/or colorants, preferably pigments.

In step b) of the method according to the invention the granular material is introduced into a receiver. According to the invention it is preferred to perform process step b) after process step a). This procedure has the advantage that the mixing of granular material and stabilising agent can be carried out in an particularly simple manner, for example in commercially available automatic mixers. With this sequence care should be taken that the granular material, despite mixing with the stabilising agent, remains pourable. Such pourability can for example be ensured by using an only weakly stabilising stabilising agent and/or by the use of a stabilising agent with a time-delayed effect.

In some cases it is more favourable to perform process step a) after process step b). In this case the granular material is first introduced into the receiver and then at least part of the granular material is provided with the stabilising agent. This procedure is in particular preferred if strong and/or rapidly solidifying stabilising agents are used.

If process step b) is carried out before process step a), it can be expedient to consolidate only part of the granular material. The consolidated part of the granular material in this case preferably forms the surface layer. The thickness and strength of the surface layer can be influenced in a simple manner via the viscosity of the stabilising agent used. Thus binding agents or adhesives with a high viscosity penetrate less deeply into the moulded article than binding agents or adhesives with a lower viscosity. Furthermore, the thickness and strength of the solidified surface layer can be controlled by the choice of the type and quantity of the stabilising agent.

Practical trials have shown that particularly decorative visible coatings can be achieved if the moulded article is formed with the use of a granular material that comprises at least two components which differ from one another optically, preferably by colour. Thus the use of a granular material, comprising components that can be differentiated by colour, allows patterns to be depicted in the moulded article which in the visible coating provide an individual, decorative appearance. This embodiment allows both natural textures to be imitated and artificial patterns to be created.

As already explained above, it is advantageous if the receiver has an at least partially deformable floor area. The deformability of the floor area can for example be achieved by the use of a flexible material as floor area. Particularly good results are achieved with floor areas made of metal and/or plastic, preferably polyurethane, polyvinyl chloride and/or silicone. These materials can, for example, be used in the form of an elastic mat or an elastic strip.

If a more stable floor area is desired, this can be achieved by selecting a more dimensionally stable material and/or by introducing fillers into the floor area. Alternatively or additionally the floor area can also comprise a reinforcing layer.

It is also an advantage if the receiver, in addition to a floor area, has at least one wall. Both the floor area and the wall are expediently designed with a smooth surface on at least the majority of their internal surface. In this way undesired irregularities in the structure of the visible covering can be avoided.

Practical trials have shown that it is particularly expedient if on the walls and/or the floor area of the receiver a film, preferably of latex, polyisobutylene, polyethylene, silicone, polyurethane, urea and/or in the form of recycling mats, is arranged as a separating and/or sliding layer.

If walls are provided in the receiver, these preferably form a sealed framework. This framework can have the most varied of forms. Frameworks that are square or rectangular have proven to be particularly expedient.

The dimensions of the receiver depend on the desired size of the visible covering. Practical trials have shown that receivers which have a square or rectangular floor area with dimensions of 1 to 5 m, preferably 2 to 4 m, by 0.3 to 3 m, preferably 0.6 to 2 m and a height of 0.05 to 0.8 m, preferably 0.1-0.5 m, produce particularly good results.

It is also advantageous if the receiver remains open in the filling direction during introduction of the granular material and remains closed, at least in the bottom and side area of the receiver, after completion of the filling process, for example during transport and/or storage.

According to a further preferred embodiment of the invention the receiver is formed in such a way that allows the entire floor area of the receiver to be raised in the filling direction. This embodiment is in particular advantageous if the filling material is removed in layers.

With a removal in layers of the granular material each new layer removed can correspond in its structuring to the previous layer. This allows, for example as with wallpaper, strips with a complementary structure to be arranged alongside each other in one sequence.

In step c) of the method according to the invention at least one surface layer of the moulded article is connected with a carrier layer.

According to the invention a surface layer means a layer of the moulded article, comprising the surface of the moulded article which faces away from the floor area of the receiver. The surface layer can comprise just one part of the moulded article or also the entire moulded article.

According to the invention the most varied of materials can be used as the carrier layer. The use of a porous carrier layer is in particular expedient. In this case the connecting of the carrier layer and the surface layer can be performed particularly easily with a binding agent and/or adhesive. To this end the carrier layer can initially be applied to the surface layer and then a binding agent and/or adhesive can be applied to the side of the carrier layer facing away from the surface layer. In this case the binding agent and/or the adhesive can penetrate the carrier layer and form the connection between the surface layer and the carrier layer. In this way a particularly good adhesion is achieved.

The use of a flexible carrier layer is also advantageous. In this case a flexible visible covering is obtained which can be applied without problem to uneven surfaces, corners and/or edges of a substrate.

Excellent results are achieved with the use of a woven material, a non-woven material and/or a meshed material as the carrier layer. If a higher strength of the carrier is desired, then in addition this can comprise a reinforcing material, such as for example reinforcing fibres. In order to increase the hardness of the visible covering, on the face of the carrier layer facing away from the surface layer a stiffening layer, such as for example a particle board and/or MDF board can also be applied.

The connecting of the surface layer and the carrier layer can be carried out in various ways, preferably using an adhesive and/or binding agent. A particularly suitable method for the use of a porous carrier layer has already been discussed.

The expediency of the various methods depends in particular on the choice of carrier layer material and on the stabilising agent used to stabilise the surface layer.

If a strong stabilising agent is used, then a consolidated surface layer already results in step a) of the method according to the invention. This can be connected to the carrier layer in a simple manner, for example by means of a connecting agent such for example as an adhesive. The use of adhesives is particularly expedient because they are easy to manipulate and have good dosability.

A particularly suitable adhesive according to the invention is a synthetic resin. The synthetic resin can be a thermoplastic or a heat-curable synthetic resin. Suitable polymers for the production of the synthetic resin comprise saturated and unsaturated polyolefins, such as for example polyethylene and polypropylene, vinyl polymers and vinyl copolymers, such as for example polyvinylchloride (PVC), polystyrene and the like; acrylate polymers, such as for example polymers and copolymers of acrylic and of methacrylic acid as well as of amides, esters, salts and corresponding nitriles thereof; polyamides; polyesters; epoxy resins; polyurethanes; mixtures and copolymers of these and other thermoplastic and heat-curing polymers, such as for example acrylonitrile butadiene styrene (ABS); and the like.

Particularly suitable polyester polymers according to the invention are polycondensation products of a dicarboxylic acid with a dihydroxy alcohol. These products can be obtained from a number of starting reagents, which comprise the following substances: maleic acid, fumaric acid, phthalic acid, isophthalic acid, terephthalic acid, adipinic acid and other acids and their anhydrides as well as ethylene, propylene, diethylene, dipropylene, 1,4-butylene and hexamethylene glycol and the like.

Particularly suitable acrylate polymers are methyl methacrylate, ethyl acrylate and acrylonitrile. The polymers can in each case be used in the form of homopolymers or with various other monomers, which allow copolymerisation. Additional explanatory examples of acrylate polymers, which are useful for the present invention, are polyacrylates and polymethacrylates, which are homopolymers or copolymers of an acrylic acid ester or a methacrylic acid ester, such as for example a polyacrylic acid isobutyl ester, a polymethacrylic acid methyl ester, a polymethacrylic acid ethyl hexyl ester, a polyacrylic acid ethyl ester, copolymers of the various acrylic and/or methacrylic acid esters, such as for example methacrylic acid methyl ester/acrylic acid cyclohexyl ester copolymers, as well as copolymers of acrylic acid esters and/or with acrylic acid esters with styrene and/or alpha-methyl styrene, such as for example the propolymers and -copolymers and polymer mixtures which are composed of acrylic acid esters, methacrylic acid esters, styrene and butadiene.

Urethane polymers which are useful in the realisation of the present invention are produced in that in a polyisocyanate, such as for example toluene diisocyanate, diphenyl methane diisocyanate and hexamethylene diisocyanate, is allowed to react with a compound having at least two active hydrogen atoms, such as for example polyol, polyamine and/or polyisocyanate. Numerous polyurethane resins that can be useful for the realisation of the invention are available.

Various epoxy resins can also be used which are produced in that an epoxy group (resulting from the combination of an oxygen atom with two further atoms, normally carbon), such as for example epichlorohydrin, or oxidised polyolefins, such as for example ethylene oxide, are reacted with an aliphatic or aromatic alcohol, such as for example bisphenol A, glycerine and so on.

Furthermore, connecting agents made from vinyl polymers can also be used, as known from the prior art, such as for example polyvinylchloride, polyvinyl acetate, polyvinylidine chloride, polyvinyl alcohol, polyvinyl acetate, polyvinyl ether, polystyrene and copolymers of these substances.

The adhesives or binding agents mentioned can also be used as stabilising agents in the method according to the invention.

Practical trials have shown that with thermoplastic dispersions, preferably on the basis of acrylate, styrene acrylate, Propiophan, elastomers or duroplasts, preferably MS-polymers, polysulphides, epoxides, polyurethanes and/or polyesters, particularly good results are obtained. Isocyanate prepolymers, polymethylmethacrylates and/or mixtures of these are likewise eminently suitable.

Depending on the application it may be expedient to reinforce an adhesive layer formed when connecting the surface layer and the carrier layer for example with a lattice.

If a weak and/or reversible stabilising agent is used as stabilising agent, then according to the invention it is advantageous to achieve the connecting of the surface layer and the carrier layer by means of a binding agent. In this case the binding agent performs two functions. Firstly, it penetrates a surface layer of the moulded article and consolidates this. Secondly it generates the connection between surface layer and carrier layer. Particularly suitable binding agents for this purpose are for example thermoplast dispersions based on acrylate, styrene acrylate, Propiophan, elastomers and thermosetting materials, such as in particular MS-polymers, polysulphides, epoxides, polyurethanes and polyesters.

Additionally on the side of the reinforcing layer facing away from the surface layer an adhesive layer can be applied for securing the visible covering to a substrate. The adhesive layer is advantageously provided with a protective layer which can be easily removed as needed. The adhesive layer can be covered with a suitable film or a similar covering as covering material, so that the visible covering can be packed, stored and transported without problems. Prior to using the visible covering the film or the covering can be removed and the visible covering easily adhered to the substrate. In this way the application of the visible covering can be performed quickly, simply and cost-effectively.

In step d) of the method according to the invention the composite of surface layer and carrier layer is removed, whereby the visible covering is obtained.

Practical trials have shown that particularly attractive visible coverings can be obtained if the surface of the moulded article before and/or after removing the composite of surface layer and carrier layer is smoothed, for example with a doctor knife and/or a level.

In some cases it has also proven to be expedient if the visible covering is post-treated for example by pressing with or without heat, by polishing, or by application of a sealing and/or protective layer.

If a higher level of compactness of the visible covering is desired, then it is advantageous if the moulded article is compacted horizontally and/or vertically, for example by pressing. Such compacting can in principle take place at the most varied instances during the method according to the invention. It is particularly expedient if the compacting of the moulded article is carried out after introduction of the granular material into the receiver and/or after connecting of the surface layer and carrier layer.

Through the compacting, which preferably takes place under the effect of heat, a considerable smoothing of the visible covering can be achieved. If desired, by means of the compacting a forming can also take place for example for modelling round or curved surfaces. If a smooth appearance of the visible covering is not desired, the surface of the visible covering can also be post-treated by roughening or structuring.

Post-treatment of the visible covering can also be performed by sealing and/or application of a protective layer. With the sealing a smooth and wear-resistant surface can be created which, if desired, can also be protected against infiltration by liquids.

If a protective layer is applied, then this can be transparent or translucent. The application of the protective layer preferably takes place on the surface of the visible covering opposite the carrier layer.

The application of the protective layer can take place using any of the usual methods for application of a protective layer to the surface of a material. These methods include, for example, spraying a solution or a dispersion of a polymer or pre-polymer onto the surface of the material, the application of a polymer or pre-polymer to the surface of the material by means of conventional coating devices, such as for example a reverse coating roller, a doctor knife, etc.

Preferably the polymer of the protective coating penetrates into at least a part of the surface of the visible covering and/or impregnates this. For this purpose, polymers are particularly suited that are suitable for outdoor use. Such weather-proof polymers comprise fluoropolymers, acrylate polymers, urethane polymers, vinyl polymers and mixtures and copolymers of these polymers. The fluoropolymers which are useful in realising the invention comprise polymers and copolymers that are made from trifluoroethylene, tetrafluoroethylene, hexafluoropropylene, monochlorotrifluoroethylene and dichlorodifluoroethylene. Copolymers of these monomers, which are produced using fluoroolefins, such as for example vinylidene fluoride, can also be used. Further illustrative example of fluoropolymers which are useful for the realisation of the present invention include polyvinylfluoride and polyvinylidene fluoride. The fluoropolymer can be a fluorinated ethylene/propylene copolymer or a copolymer of ethylene and chlorotrifluoroethylene. Vinylidene fluoride/hexafluoropropene and vinylidene fluoride/perfluoro (alkylvinyl ether) tripolymers and -terpolymers with tetrafluoroethylene are further examples of fluoropolymers that are useful for the realisation of the present invention.

The topography of the visible covering can be influenced in various ways. According to a preferred aspect of the invention the topography of the visible layer is influenced in that the non-connected fractions of the granular material are removed at defined time intervals after removal of the composite of surface layer and carrier layer.

If for example the non-connected fraction of the granular material is removed immediately after removing the composite, a visible covering with a relatively smooth surface, i.e. a low topography, can be obtained.

If on the other hand a structured visible surface is desired, then in a further preferred aspect of the invention the non-connected fraction of the granular material is only removed after a defined period after removing the visible covering. In this way also the fraction of granular material which has only a low contact area with the binding agent or adhesive can be incorporated into the visible covering. With this embodiment a visible covering with a structured topography can be produced.

The visible covering produced by the method according to the invention is eminently suitable for the most varied of purposes, for example for the facing of ceilings, walls, floors, doors and/or roofs. The visible covering produced by the method according to the invention is similarly eminently suitable as a facing for or integral component of furniture, in particular tabletops. Furthermore, the visible covering can also be used as a composite element in its own right, for example in conjunction with glass on carrier materials. Particularly pleasing optical results can be achieved if the visible covering according to the invention is closely connected by means of an adhesive with a glass panel. Here the adhesive is preferably transparent.

The visible covering according to the invention, although its surface layer compared with normally used solid materials such as sandstone is only relatively thin, has the appearance of the stone material itself. In addition the visible covering is flexible and for this reason can withstand considerable flexural and tensile loads. Because of its flexibility the visible covering can also be used on uneven or variable surfaces, in order to create a decorative surface.

In addition, the visible covering according to the invention, compared with conventional materials, is relatively light, so that it can also be applied to less stable substrates. The need to create a dimensionally stable base layer is thus avoided. Furthermore the visible covering is quick and easy to lay or process.

The most varied of materials are suitable as foundation for the visible covering according to the invention, such as for example wooden materials, plastics, concrete, screed, plaster, insulating materials, gypsum, gypsum fibres, metal and similar materials.

The thickness of the visible covering can vary within a broad range depending on the desired application. Practical trials have shown that with thicknesses of 0.005 mm to 1 cm, preferably of 0.01 mm to 5 mm, in particular of 0.05 mm to 3 mm particularly good results are achieved. As already discussed, the setting of the thickness can for example be controlled by the dimensions of the receiver and by varying the quantity applied and/or the viscosity of the binding agent.

According to a further embodiment of the invention at least one place holder is introduced into the receiver and/or into the granular material. As place holders, objects of the most varied shapes and materials can be used. As the process continues the place holders can remain in the moulded article formed and/or be removed from it. If the place holder remains in the moulded article it is expedient to use optically decorative materials such as shells, stones, etc. If the place holder is to be removed from the moulded article, it is particularly expedient to do this prior to the connecting of the surface layer and the carrier layer. The recess formed by the removal of the place holder, as previously described, can be filled with a contrast medium. With this variant according to the invention highly attractive visible coverings can be obtained.

In the following the invention is explained in more detail by reference to an embodiment shown in a drawing. This shows as follows:

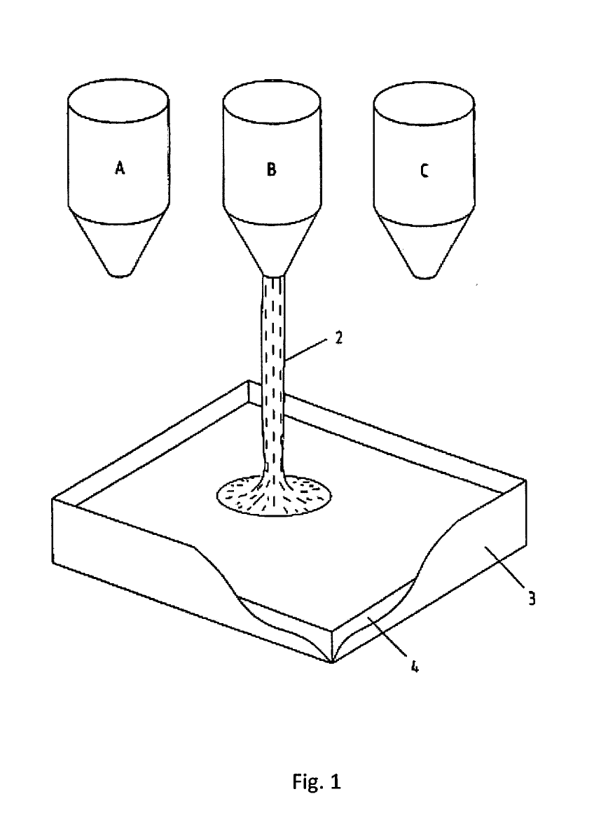

FIG. 1: The introduction process of the granular material mixed with the stabilising agent into the receiver

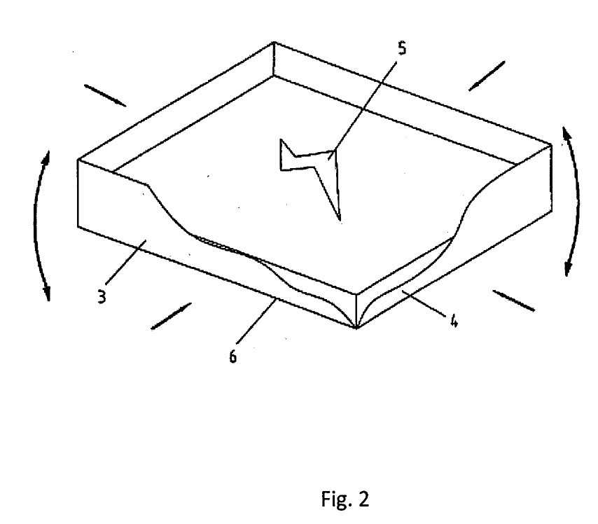

FIG. 2: The formation of a recess in the moulded article by changing the spatial positioning of the moulded article

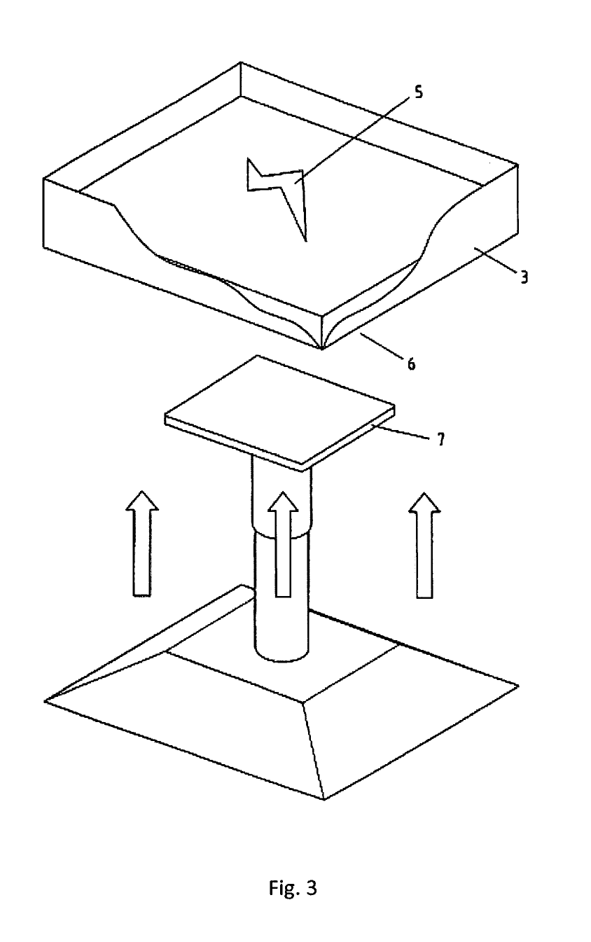

FIG. 3: The formation of a recess in the moulded article by impression of an impression body

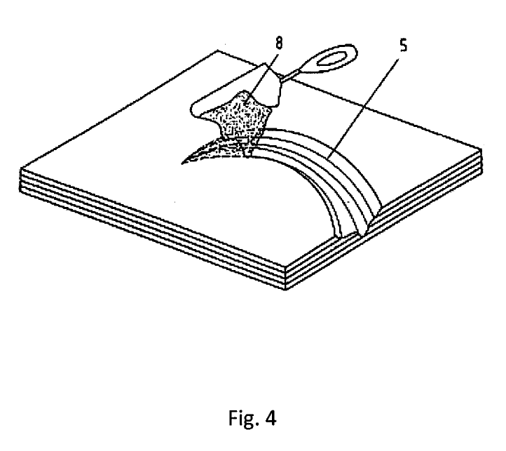

FIG. 4: The filling of a recess with a contrast medium

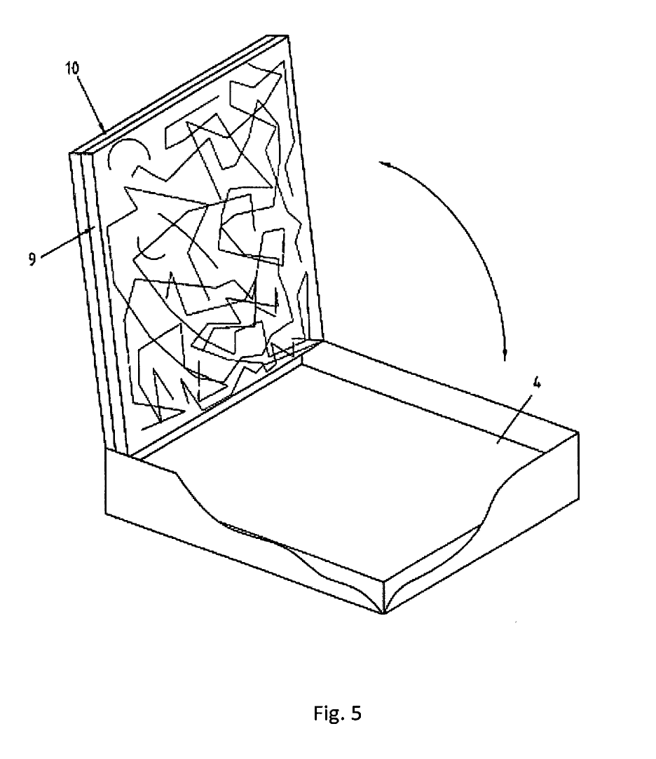

FIG. 5: The removing of a composite of surface layer of the moulded article and a carrier layer to form the visible covering according to the invention

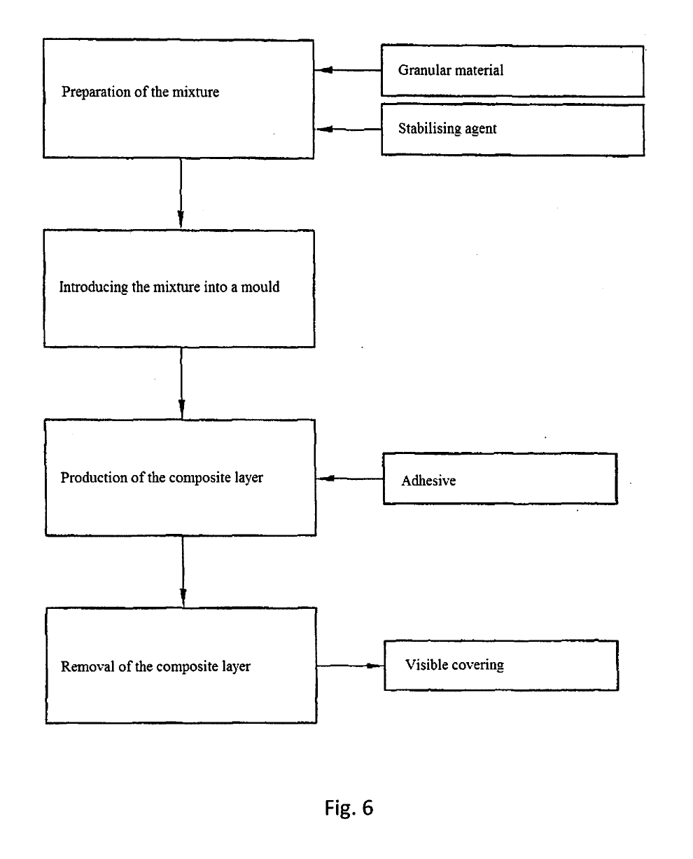

FIG. 6: A flow chart of a possible sequence of process steps for producing the visible covering according to the invention

FIG. 1 illustrates a process step for producing the visible covering 1 according to the invention. From a storage container (B) a granular material 2 is poured into a receiver 3, whereby a moulded article 4 forms. In the present case the granular material 2 is already mixed with a stabilising agent prior to filling. The mixing of granular material and stabilising agent can however also occur at a later instant, for example in the receiver 3. To this end the stabilising agent can be introduced into the receiver 3 separately from the granular material 2, for example from a further storage container (B). The granular material 2 and/or the stabilising agent can further comprise additives. These can either be introduced into the receiver 3 along with the granular material 2 and/or with the stabilising agent. The additives can, however, also be introduced separately for example via storage container (C).

FIG. 2 shows how by changing the spatial positioning of the moulded article 4 a recess 5 is formed. Here the bent arrows indicate a lateral raising of a flexible floor area 6 of the receiver 3.

FIG. 3 shows how a recess 5 is formed by impression of an impression body 7 into a flexible floor area 6 of the receiver 3.

FIG. 4 shows how a recess 5 is filled with a contrast medium 8.

FIG. 5 shows how by removing a composite of a surface layer 9 of the moulded article 4 and a carrier layer 10 a visible covering 1 according to the invention is obtained.

The flow chart in FIG. 6 illustrates a possible sequence of process steps for producing the visible covering 1 according to the invention.

1. A method for producing a visible covering comprising the following steps:
a) mixing a weak stabilising agent selected from among water, swelling clay, methyl cellulose, polysaccharides, polyvinyl alcohol, casein, loam, saponite, sephiolite, china-clay, zinc oxide and/or water glass, or any combination thereof, with a granular material; wherein said granular material is selected from among natural stone, preferably quartz, quartz sand, sandstone, granite, slate, marble, tuff, glass, plastic, wood and/or metal, or any combination thereof;
b) introducing the granular material into a receiver to form a moulded article;
c) forming at least one recess in the moulded article;
d) filling at least part of the recess with a contrast medium, wherein an artificial structure pattern forms;
e) connecting at least a surface layer of the moulded article with a carrier layer, selected from a woven material, a non-woven material and/or a meshed material, or any combination thereof;
f) removing the composite of surface layer and carrier layer, wherein the visible covering is obtained.

2. The method of claim 1 wherein said granular material is a granulate.

3. The method of claim 2, wherein said granular material is a granulate with a D50 value of about 0.02 mm to 1 mm and/or an average grain size of from about 0.1 mm-1.5 mm is used.

4. The method of claim 1, wherein said granular material comprises a fire-proofing additive, a hydrophobing agent, an odour absorber, a contaminant absorber, a reinforcing material and/or a colorant, or any combination thereof.

5. The method of claim 1, wherein the stabilising agent comprises water, cellulose, starch, saccharide, polyvinyl alcohol, casein, water glass, loam, saponite, sephiolite, china-clay, zinc oxide and/or swelling clay, or any combination thereof.

6. The method of claim 5, wherein the recess in the moulded article is formed by a change in the spatial position of the moulded article.

7. The method of claim 6, wherein the change in the spatial position of the moulded article is performed by selective, preferably one-sided, raising of the floor area of the receiver.

8. The method of claim 5, wherein the recess in the moulded article is formed by a deformation of the floor area of the receiver and/or by a deformation of a film arranged between the floor area of the receiver and the moulded article.

9. The method of claim 8, wherein the deformation of the floor area is performed by impressing an impression body.

10. The method of claim 5, wherein a contrast medium is used which in terms of grading curve structure, grain size, colour, structure and/or composition differs from the granular material.

11. The method of claim 1, wherein a receiver is used, wherein the floor area of said receiver is deformable.

12. The method of claim 11, wherein a receiver is used, wherein the floor area of said receiver is comprised of metal or an elastic plastic, preferably polyurethane, polyvinylchloride and/or silicon, or any combination thereof.

13. The method of claim 12, wherein a receiver is used, which comprises a reinforcing insert and/or filler.

14. The method of claim 13, wherein a receiver is used, on the walls and/or floor area of which a film, in particular of latex, polyisobutylene, polyethylene, silicon, polyurethane and/or urea, or any combination thereof, is arranged as a separating and/or sliding layer.

15. The method of claim 14, wherein a receiver is used, wherein the floor area of said receiver can be raised in the filling direction.

16. The method of claim 1, wherein a porous and/or flexible carrier layer is used.

17. The method of claim 1, wherein the connecting of the surface layer and carrier layer is performed with an adhesive and/or a binding agent.

18. The method of claim 1, wherein on the side of the carrier layer facing away from the surface layer a reinforcing layer is applied.

19. The method of claim 18, wherein a particle board and/or MDF board is used as the reinforcing layer.

20. The method of claim 1, wherein the surface of the moulded article before and/or after removing the composite of surface layer and carrier layer is smoothed.

21. The method of claim 1, wherein the visible covering is post-treated by pressing and/or polishing, by application of a sealing layer and/or by application of a protective layer, or any combination thereof.

22. The method of claim 1, wherein at least one place holder is introduced into the receiver and/or into the granular material.

23. A visible covering produced by the method of claim 1.

24. A use of the visible covering of claim 23 as a facing of ceilings, walls, floors, doors, roofs, furniture, and/or tabletops.
